(19) United States
(12) Patent Application Publication
(10) Pub. No.: US 2017/0337341 A1
(43) Pub. Date: Nov. 23, 2017

(54) SYSTEM AND METHOD FOR MITIGATING A MEDICAL RISK

(71) Applicant: HCL Technologies Limited, Noida (IN)

(72) Inventors: Banumathi PALANICHAMY, Chennai (IN); Sankareswari AMUDHASIDHANANDHAM, Chennai (IN); Anbuselvan VETRISELVAN, Chennai (IN)

(21) Appl. No.: 15/593,281

(22) Filed: May 11, 2017

(30) Foreign Application Priority Data
May 20, 2016 (IN) 201611017482

(51) Int. Cl. G06F 19/00

(52) U.S. Cl. CPC G06F 19/3431; G06F 19/322; G06F 19/3418

(57) ABSTRACT

Method and a system for mitigating a medical risk are disclosed. Medical profile data associated with a patient is stored in a system. One or more parameters associated with the current medical status of the patient are received from a wearable device associated with the patient. The current medical status of the patient is analyzed with respect to the stored medical profile data of the patient. Based on variations in the one or more parameters, a medical risk associated with the patient is predicted and one or more steps to mitigate the risk are generated. A notification including information about the predicted medical risk and the steps for mitigating the risk is transmitted to the wearable device for displaying to the patient.

### CROSS REFERENCE TO RELATED APPLICATIONS AND PRIORITY

The present application claims priority from Indian Patent Application No. 201611017482, filed on May 20, 2016, the entirety of which is hereby incorporated by reference.

### Technical Field

The present disclosure in general relates to the field of medical systems. More particularly, the present disclosure relates to a system and method for predicting and mitigating medical risks associated with a patient.

### BACKGROUND

People suffering from medical ailments such as lupus are prone to risks even when performing day to day activities. Close monitoring of daily activities, such as work habits, sun exposure, stress, exercise, and the like is of prime importance to such patients. Any delay in medication and/or proper treatment may be fatal to the patient. Further, many a times, it may be required for patients having such medical ailments, to alter their lifestyle on a periodic basis.

Generally, monitoring of such patients may either be done manually, through trained medical professionals such as nurses, or remotely through various devices that may monitor one or more physical parameters associated with the patient. However, such devices may hamper the movability of the patients. Also, remote monitoring of the patients by a trained medical professional remotely may not be possible.

### SUMMARY

This summary is provided to introduce aspects related to system and method for facilitating maintenance of an equipment, further described below in the detailed description. This summary is not intended to identify essential features of the claimed subject matter nor is it intended for use in determining or limiting the scope of the claimed subject matter.

In one implementation, a system for mitigating medical risks is disclosed. The system may include a memory and a processor coupled to the memory. The processor may execute a set of instructions stored in the memory to store medical profile data associated with a patient. The processor may further execute a set of instructions stored in the memory to receive, from a wearable device associated with the patient, one or more parameters associated with a current medical status of the patient. The processor may further execute instructions stored in the memory to predict a medical risk associated with the patient based on variations in the one or more parameters with respect to the medical profile of the patient over a period of time. The processor may further execute instructions stored in the memory to generate a notification to be presented to the patient, wherein the notification comprises information regarding the predicted medical risk and one or more steps to mitigate the predicted medical risk. Further, the processor may execute instructions stored in the memory to transmit the notification to the wearable device associated with the patient.

In another implementation, a method for mitigating medical risks is disclosed. The method may include storing, by a processor, medical profile data associated with a patient. The method may further include receiving, by the processor, from a wearable device associated with the patient, one or more parameters associated with a current medical status of the patient. The method may further include predicting, by the processor, a medical risk associated with the patient, based on variations in the one or more parameters with respect to the medical profile of the patient over a period of time. The method may further include generating, by the processor, a notification to be presented to the patient, wherein the notification comprises information regarding the predicted medical risk and one or more steps to mitigate the predicted medical risk. Further, the method may include transmitting, by the processor, the notification to the wearable device associated with the patient.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for mitigating medical risks, in accordance with an embodiment of the present subject matter.

FIG. 2 illustrates detailed workings of the system, in according with an embodiment of the present subject matter.

FIG. 3 illustrates a sensor device, in accordance with an embodiment of the present subject matter.

FIG. 4 illustrates a method for mitigating medical risks, in accordance with an embodiment of the present subject matter.

### DETAILED DESCRIPTION

The present systems and methods will now be described more fully hereinafter with reference to the accompanying drawings in which exemplary embodiments of the disclosure are shown. However, the disclosure may be embodied in many different forms and should not be construed as limited to the representative embodiments set forth herein. The exemplary embodiments are provided so that this disclosure will be both thorough and complete, and will fully convey the scope of the disclosure and enable one of ordinary skill in the art to make, use and practice the disclosure. Like reference numbers refer to like elements throughout the various drawings.

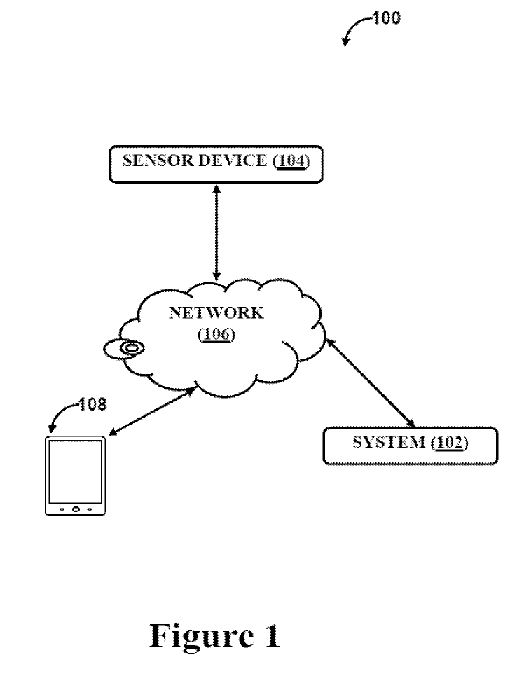

Referring to FIG. 1, a network implementation 100 of a system 102 for mitigating risks is described. The system 102 may be a computing system such as a personal computer, a server, a mainframe computer, a super computer, and the like. In an embodiment, the system 102 may have stored medical profile data for one or more patients. The medical profile data may comprise of details about the patients such as medical histories, medication details, daily activity charts, diet information, and the like. In an example, if the patient is suffering from Systemic Lupus Erythematous (SLE), the medical profile data of the patient may include a Complete Blood Count (CBC) test report, an Antinuclear Antibody (ANA) test report, blood pressure and heart rate details, and the like.

In an embodiment, the system 102 may be configured to receive data from a sensor device 104 about current medical status of one of the one or more patients. The sensor device 104, in an implementation, may be a wearable device. In an example, the sensor device 104 may be a smart watch having one or more sensors embedded to record the current medical data for the patient. In another example, the sensor device 104 may be a wrist band, a wearable mask, a bracelet, and the like. The sensor device 104 may communicate with the system 102 over a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In an embodiment, the system 102 may predict a medical risk associated with the patient based on analysis of the current medical data, received from the sensor device 104 associated with the patient. In an example, the system 102 may be configured to analyze the current medical status of the patient with respect to the medical profile data of the patient. The current medical status data may be obtained using one or more sensors embedded in the sensor device 104. Further, the current medical data may be periodically sent to the system 102 automatically or based on periodic requests.

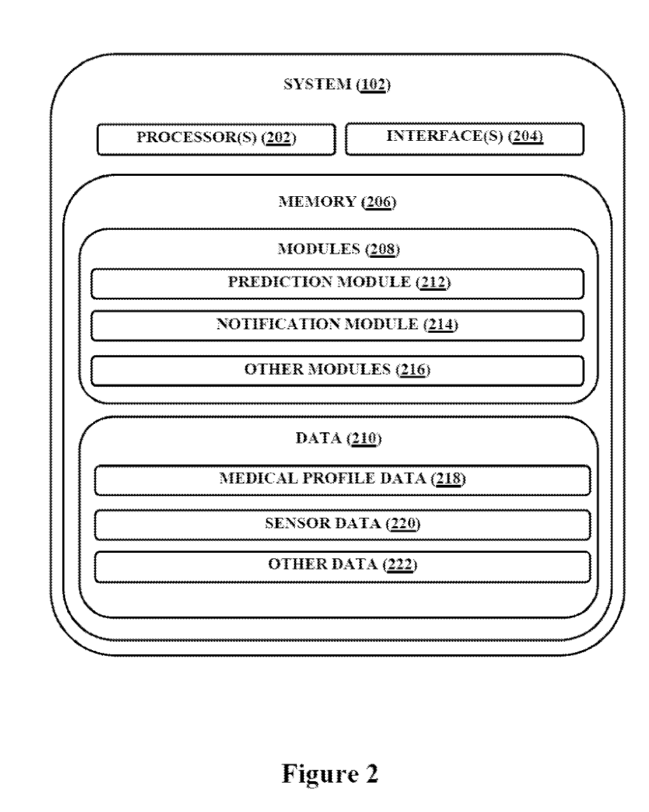

In another embodiment, the system 102 may generate a notification if a medical risk associated with the patient is predicted. In the embodiment, the system 102 may generate the notification based on periodic analysis of the current medical data of the patient with respect to the medical profile data of the patient stored in the system 102. In an example, the notification may be one of a display notification, a tactile notification or a sound notification. In an implementation, the system 102 may also transmit the generated notification to a remote mobile device 108. The remote mobile device 108, in one example, may be a mobile phone associated with the patient's emergency contact. In another example, the remote mobile device 108 may be a mobile device associated with the patient's physician or a computer located at a hospital in vicinity of the patient. Operation of the system 102 is described in detail with respect to FIG. 2.

FIG. 2 illustrates the system 102 in detail, in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions or modules stored in the memory 206.

The I/O interface 204 may include a variety of software and hardware interfaces, for example, a web interface, a graphical user interface, and the like. The I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or nonvolatile memory, such as read only memory (ROM), erasable programmable ROM, flash memories, hard disks, optical disks, a compact disks (CDs), digital versatile disc or digital video disc (DVDs) and magnetic tapes. The memory 206 may include modules 208 and data 210.

The modules 208 include routines, programs, objects, components, data structures, etc., which perform particular tasks or implement particular abstract data types. In one implementation, the modules 208 may include a prediction module 212, a notification module 214 and other modules 216. The other modules 216 may include programs or coded instructions that supplement applications and functions of the system 102.

The data 210, amongst other things, serves as a repository for storing data processed, received, and generated by one or more of the modules 208. The data 210 may also include medical profile data 218, sensor data 220 and other data 222. Each of the aforementioned modules is explained in detail in subsequent paragraphs of the specification.

In operation, a patient affected from a medical condition, such as SLE, may enter his/her medical details into the system 102, using one or more of the interface(s) 204. In an example, the medical details may include medical test reports such as ANA and CBC tests, blood tests, ECG and EMG reports, activity charts, diet charts, infection details, allergy details, and the like. In an alternative, medical details for the patient may also be directly pulled from hospital records of the patient. Further, the patient's doctor may also upload the medical details of the patient through his/her own database. In an implementation, the medical details of one or more patients may be stored in the system 102 as medical profile data 218.

In an implementation, the medical profile data 218 may be received by the prediction module 212. The prediction module 212 may further receive current medical status of the patient from the sensor device 104. In an example, the current medical status of the patient may include data recorded by one or more sensors embedded in the sensor device 104. For example, the current medical status may include information about ultraviolet (UV) ray exposure, ECG readings, EMG readings, step count, blood pressure, temperature, and the like for the user. In an example, the prediction module 212 may receive the current medical status from the sensor device 104 on a periodic basis.

In an embodiment, the prediction module 212 may process the current medical status received from the sensor device 104 in order to predict a medical risk associated with the patient. The prediction module 212 may analyze the current medical status of the patient with respect to the medical profile data 218 of the patient. Further, the prediction module 212 may predict the medical risk associated with the patient by identifying variations in the current medical status from the medical profile data 218, over a predetermined period of time. In another embodiment, in case it is determined that the patient is about to encounter the medical risk, one or more steps for mitigating the medical risk may also be generated. In an implementation, an analysis report and the one or more steps for mitigating the medical risk may be sent by the prediction module 212 to the notification module 214.

In an embodiment, the notification module 214 may generate a notification to be sent to the sensor device 104 associated with the patient. In an implementation, the notification may include the analysis report computed by virtue of analysis of the current medical status of the patient against the medical profile data 218 of the patient. The notification may also include one or more steps for mitigating the medical risk associated with the patient. In an implementation, the notification may be at least one of a display notification, a sound notification, a tactile notification, or a combination thereof. Working of the system 102 may be understood in detail based on the below example.

In an example, a patient suffering from SLE may store his/her medical profile into the system 102. The medical profile may include data about CBC reports, ANA reports, antibody blood test reports, ECG and EMG reports and the like. The medical profile may be stored in the system 102 within the medical profile data 218. In an implementation, the prediction module 212 may process the medical profile data 218 to set threshold values for each parameter in the medical profile of the patient. For example, lower and upper thresholds for blood pressure may be set at 120 over 80 and 140 over 90, respectively. In another example, lower and upper thresholds of ANA may be set at 1:40 titers and 1:60 titers, respectively. Similarly, other parameters may also have set upper and lower thresholds. Some examples include duration of exposure to UV rays, active and inactive postures, body temperature, muscle wear and tear, and the like. In an example, thresholds for the one or more parameters may be stored within the system 102 as the medical profile data 218.

As described in the foregoing, the prediction module 212 may also receive the current medical status of the patient from the sensor device 104. In an implementation, the current medical status for the patient, suffering from SLE, may include details about duration of exposure to UV rays, skin abnormalities, body temperatures, blood pressure values, muscle abnormalities, and the like for the patient. In an implementation, the prediction module 212 may store the data received from the sensor device 104, as the sensor data 220. In an example, the prediction module 212 may record the current medical status for the patient, for a predetermined period of time. Further, the prediction module 212 may analyze the current medical status against upper and lower thresholds of the one or more parameters of the patient's medical profile data 218. In an example, the prediction of a medical risk may be performed as given below:

Each parameter in the medical profile data 218 of the patient may be denoted by values such as M1, M2, and the like. Similarly, the data from the one or more sensors embedded in the sensor device 104 may be denoted by s1, s2, s3, and the like. While analyzing the data, the prediction module 212 may use a mathematical equation given by

X=M1(s1*s2*s3 . . . )+M2(s1*s2*s3)+ . . .

Wherein X denotes a threshold value for a predicted risk condition. Based on the final value of X, it may identify whether the patient would be encountering the medical risk.

In case a medical risk to the patient is identified, the prediction module 212 may generate one or more steps to mitigate the medical risk for the patient. For example, in case it is identified that the patient has been overexposed to UV rays and the patient has a risk of rashes, the prediction module 212 may generate a note stating, “overexposure to UV rays, patient advised to stay indoors and be hydrated”. In another example, in case it is determined that the patient has a high blood pressure, the prediction module 212 may generate a note stating: “high blood pressure, patient advised to relax and have lemon juice”. The prediction module 212 may transmit the analysis of the current medical status, details of the predicted medical risk, and the one or more steps generated for mitigation of the medical risk to the notification module 214.

The notification module 214 may generate the notification to be transmitted to the sensor device 104 associated with the patient. In an example, the notification may include details about the predicted medical risk and one or more steps to mitigate the predicted medical risk. The notification may be one of a sound notification, a display notification, a tactile notification, or a combination thereof.

In an embodiment, the notification module 214 may also transmit the notification to the remote mobile device 108. In the embodiment, the remote mobile device 108 may be a mobile device associated with the patient's emergency contact. In an example, the remote mobile device 108 may also be a computing system of a hospital in vicinity of the patient. In an implementation, the patient may register details of emergency contact(s) as well as preferred hospitals while uploading the medical details into the system 102.

In another embodiment, the medical profile data 218 for the patient may be updated periodically. In an example, the medical profile data 218 may be updated based on an input from the patient. In another example, the medical profile data 218 may also be updated based on medical updates associated with the patient received from the patient's physician and/or preferred hospital.

In yet another embodiment, the system 102 may generate suggestions for the patient for improvement of the patient's daily lifestyle. In an example, the suggestions may include relaxing and exercising techniques, medications, diet information, and the like. In an example, the suggestions may be generated based on analyzing data from the medical profile data 218 and the current medical status of the patient. The suggestions, in an implementation, may be transmitted to the sensor device 104 and/or to the remote mobile device 108.

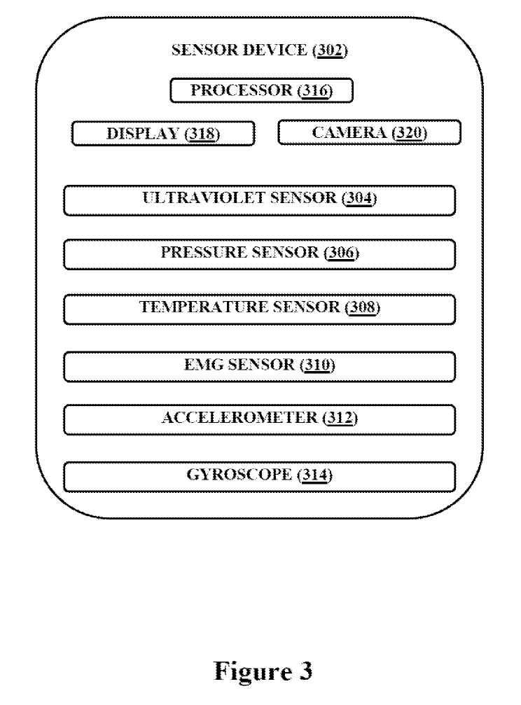

Referring to FIG. 3, an exemplary sensor device 302 is disclosed. In one embodiment, the sensor device 302 may be a wearable device. For example, the sensor device 302 may be a watch, a bracelet, a wearable mask, and the like. In an implementation, the sensor device 302 may comprise of one or more sensors, as depicted by 304-314, embedded in a manner that each sensor may comprise of a node (not shown) placed on the patient's body. The nodes may measure one or more parameters associated with the current medical status of the patient. The sensors 304-314 may record the one or more parameters and transmit to a processor 316. The processor 316 may process and compile the data for transmission to the system 102.

As depicted, the sensor device 302 may include sensors including, but not limited to, an ultraviolet (UV) sensor 304, a pressure sensor 306, a temperature sensor 308, an EMG sensor 310, an accelerometer 312 and a gyroscope 314. The UV sensor 304 may configured to measure extent of exposure of the patient to UV rays. The UV sensor 304 may calculate the amount of UV rays and the time of exposure of the patient to the UV rays. The pressure sensor 306 may be a blood pressure measuring device. The pressure sensor 306 may take periodic blood pressure readings for the patient.

The temperature sensor 308, in an example, may be configured to record the patient's body temperature. The temperature sensor 308 may also be configured to record change in temperature of the patient's body, over a period of time. The temperature sensor 308, in one example, may be a thermistor that may be set by the patient using one or more preconfigured settings such as temperature range, mode of measurement, and the like. The EMG sensor 310 may be a surface type sensor. The EMG sensor 310, in one implementation, may be configured to record electrical activity produced by skeletal muscles of the patient. Data recorded by the EMG sensor 310, in one example, may be used to identify one or more muscle abnormalities of the patient.

The accelerometer 312 and the pedometer 314 may be configured to record parameters such as number of steps, total distance traveled, velocity, and the like associated with the patient. The data from the accelerometer 312 and the pedometer 314 may be used to identify a daily activity chart for the patient. Further, periodic readings from the accelerometer 312 and the pedometer 314 may be utilized in keeping a real-time track of the patient's activities.

In an embodiment, the sensor device 302 may further include a camera 320 and a display 318. In an implementation, the camera 320 may be configured to capture images of different parts of the patient's skin. The images may be useful in identifying any flare in allergies or rashes for the patient. For example, in case the patient is suffering from SLE, the images captured by the camera 320 may be utilized to identify butterfly rashes on the user's skin. In case such rashes are identified, the patient may be warned about the condition.

The display 318, in one implementation, may be used to display one or more notifications received from the system 102. In an example, the one or more notifications may include data about a predicted medical risk and steps to mitigate the medical risk. In another implementation, the display 318 may also display data recorded by the sensors 304-314. The data recorded by the sensors 304-318, may help the patient keep a track of his/her medical conditions. In yet another implementation, the display 318 may also display one or more suggestions received from the system 102, for improving the patient's daily lifestyle. The display 318, for example, may display suggested exercises, diet charts, medications, etc. associated with the patient's medical condition.

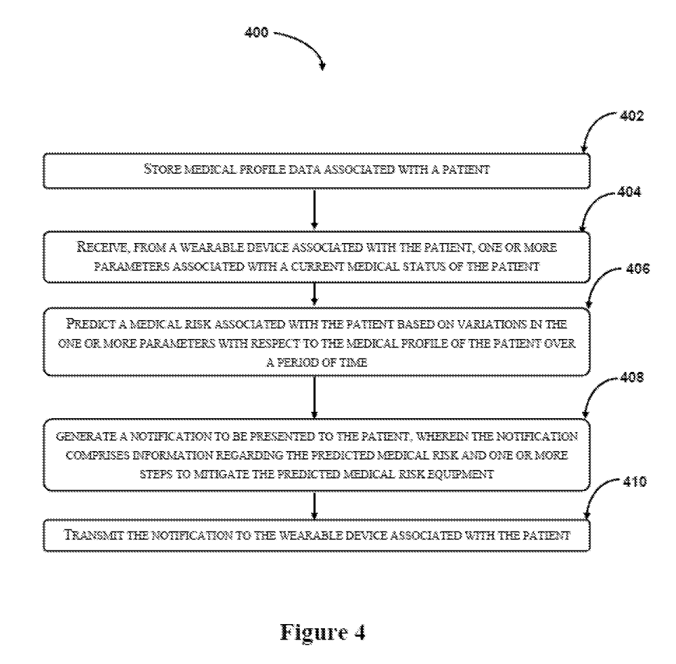

Referring now to FIG. 4, a method 400 for mitigating a medical risk associated with a patient. The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above described system 102.

The method starts at step 402, wherein medical profile data associated with a patient may be stored. In an example, the medical profile data may be received by means of a user input. In another example, the medical profile data for the patient may be automatically pulled from medical records of the patient stored at a hospital or a medical database associated with the patient.

At step 404, one or more parameters associated with a current medical status of the patient may be received from a wearable device associated with the patient. In an example, the one or more parameters may include exposure to UV rays, body temperature, skin abnormalities, muscle wear and tear, and the like.

At step 406, a medical risk associated with the patient may be predicted. In an implementation, the medical risk may be predicted based on analysis of variations of the one or more parameters with respect to the medical profile data.

At step 408, a notification to be presented to the patient may be generated. The notification may comprise information about the predicted medical condition and one or more steps to mitigate the predicted risk. Further, at step 410, the notification may be transmitted to the wearable device associated to the patient.

Although implementations for methods and systems for enabling a maintenance activity of an equipment have been described in language specific to structural features and/or methods, it is to be understood that the appended claims are not necessarily limited to the specific features or methods described. Rather, the specific features and methods are disclosed as examples of implementations for performing a maintenance activity on an equipment.

We claim:

1. A system for mitigating a medical risk, the system comprising:
a memory;
a processor coupled to the memory, wherein the processor is configured to execute stored instructions in the memory to:
store medical profile data associated with a patient;
receive, from a wearable device associated with the patient, one or more parameters associated with a current medical status of the patient;
predict a medical risk associated with the patient based on variations in the one or more parameters with respect to the medical profile of the patient over a period of time;
generate a notification to be presented to the patient, wherein the notification comprises information regarding the predicted medical risk and one or more steps to mitigate the predicted medical risk; and
transmit the notification to the wearable device associated with the patient.

2. The system of claim 1, wherein the medical profile data comprises medical history, medication data, daily activity charts, diet charts and exercise data associated with the patient.

3. The system of claim 1, wherein the one or more parameters associated with the current medical status associated with the user comprises information about exposure to ultraviolet (UV) rays, body temperature, blood pressure, heart rate, number of steps, muscle abnormalities and skin abnormalities for the patient.

4. The system of claim 1, wherein the notification is at least one of a display notification, a tactile notification, and a sound notification.

5. The system of claim 1, wherein the processor is further configured to execute instructions stored in the memory to periodically update the medical profile data associated with the patient based on a user input.

6. The system of claim 1, wherein the processor is further configured to execute instructions stored in the memory to transmit the notification to a remote mobile device.

7. A method for mitigating a medical risk, the method comprising:
storing, by a processor, medical profile data associated with a patient;
receiving, by the processor, from a wearable device associated with the patient, one or more parameters associated with a current medical status of the patient;
based on variations in the one or more parameters with respect to the medical profile of the patient over a period of time, predicting, by the processor, a medical risk associated with the patient;
generating, by the processor, a notification to be presented to the patient, wherein the notification comprises information regarding the predicted medical risk and one or more steps to mitigate the predicted medical risk; and
transmitting, by the processor, the notification to the wearable device associated with the patient.

8. The method of claim 1, wherein the medical profile data comprises medical history, medication data, daily activity charts, diet charts and exercise data associated with the patient.

9. The method of claim 1, wherein the one or more parameters associated with the current medical status associated with the user comprises information about exposure to ultraviolet (UV) rays, body temperature, blood pressure, heart rate, number of steps, muscle abnormalities and skin abnormalities for the patient.

10. The method of claim 1, wherein the notification is at least one of a display notification, a tactile notification, and a sound notification.

11. The method of claim 1, further comprising periodically updating, by the processor, the medical profile data associated with the patient based on a user input.

12. The method of claim 1, further comprising to transmitting, by the processor, the notification to a remote mobile device.
